(19) United States
(12) Patent Application Publication
(10) Pub. No.: US 2026/0291231 A1
(43) Pub. Date: Sep. 24, 2026

(54) System and Method for Stochastic Operational Hosting Capacity Optimization with Dynamic Grid Reconfiguration

(71) Applicant: Mitsubishi Electric Research Laboratories, Inc., Cambridge, MA (US)

(72) Inventors: Hongbo Sun, Boston, MA (US); Jingtao Qin, Boston, MA (US); Jianlin Guo, Boston, MA (US); Ye Wang, Boston, MA (US); Arvind Raghunathan, Boston, MA (US)

(73) Assignee: Mitsubishi Electric Research Laboratories, Inc., Cambridge, MA (US)

(21) Appl. No.: 19/086,861

(22) Filed: Mar. 21, 2025

Related U.S. Application Data
(60) Provisional application No. 63/771,775, filed on Mar. 14, 2025.

(51) Int. Cl. H02J 3/00; G05B 13/02; H02J 3/38

(52) U.S. Cl. CPC H02J 3/003; G05B 13/028; H02J 3/004; H02J 3/381; H02J 2103/30

(57) ABSTRACT

A method for controlling power distribution in a power grid with Distributed Energy Resources (DERs) integrated into the power grid is disclosed. A topology of the power grid is formed by various switch controllers and voltage regulators. The method includes generating multiple representative scenarios forecasting DERs generation and load demand in the power grid over a prediction horizon. The method further includes determining control schedules for reconfigurable parameters of the power grid by employing an optimization technique by minimizing expected curtailment of the DERs while satisfying all generated scenarios as constraints. Moreover, the method includes translating the optimized control schedules into executable commands for one or a combination of the DERs, voltage regulators, and switch controllers. Furthermore, the method includes controlling one or a combination of the DERs, voltage regulators, and switch controllers of the power grid according to the executable commands.

### TECHNICAL FIELD

The disclosure relates generally to power distribution systems and more particularly to system and method for stochastic hosting capacity optimization with dynamic grid reconfiguration.

### BACKGROUND

The widespread adoption of distributed, intermittent, and bi-directional Distributed Energy Resources (DERs) at the grid's edge poses significant technical and operational challenges to power grid operation and planning. One key challenge is evaluating the capability of a power distribution system to utilize renewable energy without infrastructure upgrades under constantly varying and unpredictable generation and demand conditions.

Hosting capacity refers to the amount of DERs that can be accommodated on the distribution system at specific times and locations under existing grid infrastructure and operation conditions. It is typically categorized into two types: extendable hosting capacity and operational hosting capacity. Extendable hosting capacity refers to the amount of extra generation or load that the grid can accommodate at a particular time and location without compromising safety, reliability, or power quality. This metric is generally used for planning purposes. Operational hosting capacity refers to the maximum amount of generation or load that the grid can handle at a specific time and location to ensure stable and efficient operation under existing infrastructure with allowed network reconfiguration. This metric is primarily used for the operation and control of power distribution systems.

There are serval works existing on hosting capacity analysis or assessment. Patent application US20230238801A1 described a generic dynamic time-series hosting capacity analysis framework, which consider distributed energy resources (DERs) dynamics and system dynamics. Example implementations can involve systems and methods that receive data input comprising system profiles and topology information of a distribution system having a plurality of DER nodes in an interconnect; execute feeder topology analysis on the topology information to generate output analysis; execute scenario management on the system profiles to generate simulation scenario sets; and load and execute a simulation flow from the simulation scenario sets and the output analysis.

Another example is patent application US20200091765A1 that discussed methods for determining a distribution system's hosting capacity for distributed power generation assessed on a feeder-by-feeder basis. Performing a hosting capacity assessment may include randomly selecting spot load points in a feeder as candidates for installation of distributed power generation sources. The hosting capacity assessment may be repeated several times to ensure optimal results and to correct for any violations of system performance parameters caused by an addition of distributed power generation at a given spot load point.

Yet another example is patent application U.S. Pat. No. 10,873,188B2 that described a method for a distributed energy resource management system to utilize capacity on a distribution grid to host further distributed energy resource interconnections. The system utilizes a data store including operational values associated with distributed electric resources on an electric power distribution network and a processor or processors coupled to the data store and in communication with the distributed electric resources. The computer processors are programmed, upon receiving one or more requests, to create 3-phase AC power flows for each location across the electric power distribution network. Optimizations of the 3-phase AC power flows to are used to calculate hosting capacity for each of the locations, for each of a plurality of time intervals, and each of a plurality of types of distributed energy resource, as a dynamic quantity that can change depending on time, day, season, and location. The hosting capacity is translated into calculated operational values which are used to determine and send a direction to actively manage distributed energy resources on the electric power distribution network.

Although these studies have addressed renewable hosting capacity assessment to some extent, several key issues remain inadequately explored. The modeling of uncertainty in renewable generation and load demand does not fully capture the complexities of their stochastic variations. The absorbing capacity of existing infrastructure for renewable energy has not been thoroughly examined, particularly through the use of existing regulatory mechanisms such as transformer tap-changing or network reconfiguration via switch operations. Additionally, the computational burden of assessing hosting capacity needs to be significantly reduced to support real-time operation and control.

### SUMMARY

The disclosure provides a fast assessment approach for evaluating renewable operational hosting capacity of a power distribution system with dynamic adjustments of voltage regulator positions and switch statuses to maximize renewable utilization under renewable and load forecast uncertainty.

The disclosure provides for assessing operational hosting capacity at each time interval under renewable and load forecast uncertainty. Gaussian Mixture Model (GMM) is used to predict DER generation and load demand by grouping DERs and loads into clusters. A set of representative scenarios is strategically chosen based on GMMs to effectively capture the actual PV generation and load demand with less computation time but without sacrificing representativeness.

Operational hosting capacity is determined by maximizing DER generation, which is equivalent to minimizing DER curtailment. Therefore, the stochastic dynamic hosting capacity problem is formulated as minimizing the expected DER curtailment over all scenarios and time intervals, subject to three-phase load flow models and related operational constraints. The linearized load flow model is used to express branch voltage drops and bus power balances in terms of squared voltage magnitudes, as well as active and reactive power flows, incorporating multi-tap voltage regulation and discrete switch statuses. The voltage changes resulting from transformers are linearized using the Special Ordered Set (SOS) Type 1 method and the Big M method. Branch thermal capacity limits are simplified into 8 linear constraints, which include limits on active power, reactive power, and sum of active power and reactive power apparent power. Temporal relationships between switch statuses, transformer tap positions, and voltage violation durations are integrated to link multiple time-interval optimization together.

A temporal decomposition approach with the Surrogate Lagrangian Relaxation (SLR) algorithm to accelerate the solving time for stochastic operational hosting capacity optimization model (S-HC). First, the temporal constraints are dualized and the objective function of S-HC is augmented by incorporating the product of the Lagrange multipliers and the temporal constraints, and a relaxed stochastic operational hosting capacity optimization model (RS-HC) is formulated. Then, the augmented RS-HC is decomposed into multiple individual period-level subproblems. A subproblem for a sub-period at an iteration is defined by fixing the variables in other subproblems to the values obtained from the previous iteration. After that, the multipliers are updated after solving each subproblem by selecting step sizes always decreasing objective value of RS-HC based on related surrogate subgradient. The Surrogate Lagrangian Relaxation Method selects step sizes in a way that distances between Lagrange multipliers at consecutive iterations decrease, and as a result, multipliers converge to a unique limit. At the same time, step sizes are kept sufficiently large so that the algorithm does not terminate prematurely. At convergence, a surrogate dual value provides a lower bound to the primal cost.

The temporal decomposition integrated with Surrogate Lagrangian Relaxation algorithm is proposed to accelerate the solution process of stochastic operational hosting capacity maximization that formulated as a mixed integer linear programming (MILP) problem. Compared with conventional MILP solvers, the proposed algorithm can reach same or better solutions with significant time savings.

Another embodiment discloses a method for controlling power distribution in a power grid with Distributed Energy Resources (DERs) integrated into the power grid. A topology of the power grid is formed by various switch controllers and voltage regulators. The method includes generating multiple representative scenarios forecasting DERs generation and load demand in the power grid over a prediction horizon. The method also includes determining control schedules for reconfigurable parameters of the power grid by employing an optimization technique by minimizing expected curtailment of the DERs while satisfying all generated scenarios as constraints. The method further includes translating the optimized control schedules into executable commands for one or a combination of the DERs, voltage regulators, and switch controllers. Thereafter, the method includes controlling one or a combination of the DERs, voltage regulators, and switch controllers of the power grid according to the executable commands.

Yet another embodiment discloses a system for controlling a power grid. The system comprises a processor configured to execute instructions to generate multiple representative scenarios forecasting DERs generation and load demand in the power grid over a prediction horizon. The processor is also configured to execute instructions to determine control schedules for reconfigurable parameters of the power grid by employing an optimization technique by minimizing expected curtailment of the DERs while satisfying all generated scenarios as constraints. The system also includes a memory storing instructions and parameters for generating multiple scenarios and determining control schedules for reconfigurable parameters. The system also includes a controller configured to control the power grid based on the determined control schedules and using the instructions and parameters stored in the memory.

### BRIEF DESCRIPTION OF THE DRAWINGS

FIG. 1 shows a method for controlling power distribution in a power grid with Distributed Energy Resources (DERs) integrated into the power grid.

FIG. 2 shows a method for generating multiple representative scenarios for energy generation and load demand for the power grid.

FIG. 3 shows a method for training a Gaussian Mixture model (GMM) for generating the multiple representative scenarios for energy generation and load demand for the power grid.

FIG. 4 shows a method for solving an optimization problem to determine control schedule for reconfigurable parameters of the power grid.

FIG. 5 shows a method for implementing SLR algorithm to solve the optimization problem to determine control schedule for reconfigurable parameters of the power grid.

FIG. 6A shows a schematic of three-phase distribution line model.

FIG. 6B shows a schematic of distribution branch with an equivalent voltage regulator model.

FIG. 7 shows a schematic of one circular constraint simplified using two rectangular constraints.

FIG. 8 shows a schematic of clusters for Gaussian mixture model.

FIG. 9 shows a schematic of computing device that is representative of any system or collection of systems in which the various processes, programs, services, and scenarios of some embodiments disclosed herein are implemented.

FIG. 10 is a schematic of an example power grid.

FIG. 11 shows a schematic of progress on the upper and lower bounds for solving the 24-hour S-HC and RS-HC.

FIG. 12A shows a schematic of switch reconfiguration results of SLR.

FIG. 12B shows a schematic of switch reconfiguration results of MILP.

FIG. 13A shows a schematic of tap setting results of SLR.

FIG. 13B shows a schematic of tap setting results of MILP.

### DETAILED DESCRIPTION

### Overview of the Contribution to the Art

This overview is provided to introduce a selection of concepts in a simplified form that are further described below in the Detailed Description. This Overview is not intended to identify key features or essential features of the claimed subject matter, nor is it intended to be used as an aid in determining the scope of the claimed subject matter.

### The Challenge of Integrating Distributed Energy Resources (DERs)

The transition to renewable energy is transforming power distribution systems, with Distributed Energy Resources (DERs) such as solar and wind playing an important role in modern grids. However, these resources are intermittent, distributed, and bi-directional, presenting significant technical and operational challenges. Traditional power grids were designed for one-way power flow, where electricity moves predictably from central power plants to consumers. The introduction of DERs disrupts this established model, leading to voltage stability issues, frequency fluctuations, and network congestion.

One of the most pressing concerns is hosting capacity, which defines the maximum amount of power generated by the DERs that can be accommodated without requiring major infrastructure upgrades. Hosting capacity is generally categorized into extendable hosting capacity, which considers infrastructure modifications, and operational hosting capacity, which assesses real-time grid constraints. The primary challenge in operational hosting capacity assessment is the accurate modeling of uncertainties in renewable generation and load demand while incorporating grid reconfiguration techniques such as feeder switching and voltage regulation to enhance grid flexibility.

### Recognizing the Root of the Problem

Various embodiments aim to improve the operational hosting capacity of DERs efficiently while addressing uncertainty and allowing dynamic grid reconfiguration. Existing approaches have limitations in handling stochastic variations in DER generation and load demand. Existing approaches typically rely on deterministic simulations or a single-scenario modeling, which do not fully capture real-world uncertainties.

For example, some embodiments recognize the need for and benefits of more accurately capturing the uncertainty spectrum of DER generation and load demand to improve prediction accuracy. Existing methods that rely solely on Monte Carlo simulations or deterministic approaches fail to account for real-world stochastic variations in renewable output and electricity consumption. The impact of extreme weather events and rapid demand shifts further amplifies these inaccuracies, diminishing the reliability of traditional hosting capacity assessments.

Also, some embodiments recognize the potential of network reconfiguration as a strategy to increase hosting capacity. Techniques such as feeder switching, voltage regulator adjustments, and transformer tap changes enhance the grid's ability to accommodate DERs. Assuming a fixed network topology overlooks the opportunity to dynamically balance power flows and optimize voltage levels in response to changing conditions. However, enabling network reconfiguration increases computational complexity, particularly when combined with the stochastic nature of power generation and load demand prediction.

Even with an accurate model, solving the operational hosting capacity problem in real-time remains a significant computational challenge. If the number of possible scenarios, length of scheduling horizon and network configurations is allowed to increase exponentially, traditional Mixed-Integer Linear Programming (MILP) solvers become impractical for large-scale distribution networks. Consequently, the lack of efficient computational techniques hinders the real-world implementation of advanced hosting capacity assessments, particularly when incorporating uncertainty and dynamic network reconfiguration.

To address these challenges, the disclosure is based on several key technical recognitions that exist independently of any specific solution but are important for improving DER integration:

Hosting Capacity is Dynamic and Stochastic-Traditional hosting capacity assessments assume fixed power flows and static network configurations. However, DER hosting capacity varies due to fluctuating generation, load demand, and switching operations. Recognizing this variability is essential for accurate and effective control strategies.

Uncertainty in Renewable Generation and Load Demand need to be Explicitly Modeled—Renewable resources are inherently unpredictable, and relying on single-scenario forecasts or deterministic approaches leads to inaccurate planning. A probabilistic representation is necessary to ensure robust grid operations under uncertainty.

Grid Flexibility Through Reconfiguration is Underutilized-Existing methods often overlook the potential of adjusting switch statuses, voltage regulator tap positions, and transformer settings to increase hosting capacity. Recognizing that network reconfiguration can be an effective alternative to costly infrastructure upgrades is critical.

Not All Scenarios Are Equally Important—A comprehensive yet computationally feasible approach to uncertainty recognizes that a subset of representative scenarios has the ability to capture system behavior efficiently. This avoids excessive computational burdens while maintaining accuracy.

Traditional Optimization Techniques Are Too Slow for Real-Time Use—Large-scale power grids involve complex interactions, making traditional Mixed-Integer Linear Programming (MILP) solvers impractical for real-time decision-making. Recognizing the need for a more efficient optimization approach is fundamental to achieving scalable solutions.

Balancing DER Utilization with Grid Stability is a Key Trade-Off-Maximizing DER output without considering operational constraints, generally, causes voltage violations and overloads. Recognizing this trade-off enables a structured optimization framework that minimizes curtailment while ensuring grid stability.

### Key Insights Driving the Solution

Some embodiments leverage the advantage and capability of generating multiple representative scenarios for Distributed Energy Resources (DER) forecasting. Instead of relying on a single most-likely forecast, which fails to capture the full spectrum of uncertainties and variations in power distribution systems, this solution integrates multiple scenarios into an optimization framework to account for uncertainty effectively.

As used herein, a scenario refers to a specific example of DER generation and load demand over a defined prediction horizon, such as 24 hours. Since the power grid spans vast territories and includes numerous DERs that are influenced by varying weather conditions, scenarios encapsulate these variations within a prediction model. Each scenario represents different possible conditions for DER output and energy consumption, accounting for spatial and temporal variability.

Different embodiments employ various techniques to generate these scenarios. For example, some embodiments leverage machine learning techniques such as training neural networks on historical data, while others use statistical methods like sampling from a pre-trained Gaussian Mixture Model (GMM). By dynamically updating the weights of different GMM models based on the latest forecasts, these scenarios are sampled from the GMM to represent fluctuations in DER generation and load demand in a manner that optimization solvers efficiently handle.

To that end, some embodiments incorporate multiple scenarios into the optimization process to better represent grid uncertainty, making it more adaptable for solvers to handle real-world variability effectively. This approach not only improves forecast accuracy but also enables robust decision-making in power grid management, ensuring optimal resource utilization under uncertain conditions.

To achieve this, some embodiments optimize grid reconfiguration to minimize curtailment while satisfying the requirements of each scenario. Instead of solely focusing on maximizing DER utilization, the optimization process is structured to minimize expected curtailment while ensuring that satisfaction of all generated scenarios serves as constraints. The optimization solution is designed to accommodate each scenario while reducing the expected curtailment of DERs.

Notably, maximizing renewable generation without considering grid constraints lead to voltage violations, overloaded lines, and voltage imbalances. By instead focusing on minimizing curtailment, the optimization process ensures maximum renewable utilization within operational limits, preventing instability and power quality issues. The solution extends beyond static assessments by integrating switching operations, voltage regulator adjustments, and transformer tap changes into the optimization model. This dynamic reconfiguration of the network significantly enhances hosting capacity without requiring costly infrastructure upgrades.

This approach significantly enhances computational efficiency by allowing solvers to estimate power grid parameters in a structured manner, thereby reducing the complexity of the solution space. By integrating scenario-based constraints, the method effectively determines optimal reconfiguration parameters, such as voltage regulator tap positions and switch statuses, ensuring that the power grid remains stable. Furthermore, the method maximizes the feasible accommodation of DER generation while explicitly considering the uncertainty captured in the generated scenarios.

Finally, the solution provides actionable scheduling for grid operations. Once the optimization problem is solved, the output consists of precise control schedules for renewable generation dispatch, voltage regulator tap settings, and feeder switch statuses. The determined control schedules are then converted into actionable commands to be executed by renewable energy units, voltage regulators, and switch controllers. This real-time grid reconfiguration capability enhances operational efficiency and ensures that power distribution systems dynamically adapt to varying conditions, ultimately improving the reliability and sustainability of energy management.

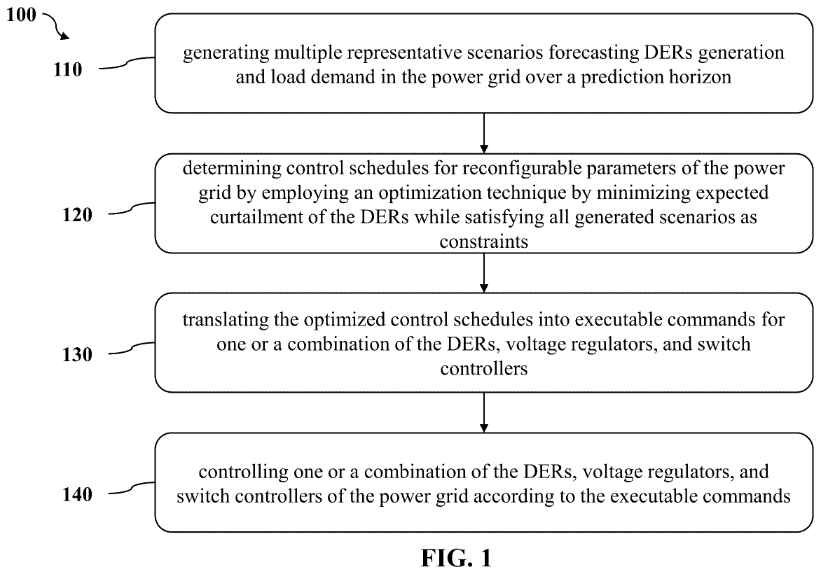

Leveraging these recognitions, the disclosure introduces an advanced framework for stochastic hosting capacity assessment and dynamic grid reconfiguration. Referring to FIG. 1, an example method 100 for stochastic hosting capacity assessment and dynamic grid reconfiguration is disclosed. The method 100 is performed by processor and instructions and any additional data or model to perform the method are stored inside a memory. The method at step 110 generates a plurality of representative scenarios, forecasting DERs generation and load demand in the power grid over a prediction time horizon, for example, 24 hours. Since the power grid spans vast territories and includes numerous DERs influenced by varying weather conditions, and scenarios encapsulate these variations within a prediction model. Each scenario represents different possible conditions for DER output and energy consumption, accounting for spatial and temporal variability. For example, a scenario could define a set of generation ratios relative to the maximum capacities for all generation units at each time step, as well as a set of load ratios relative to the maximum demands for loads at each step under typical daily weather conditions.

Different embodiments employ various techniques to generate these scenarios. For example, some embodiments leverage machine learning techniques such as training neural networks on historical data, while others use statistical methods like sampling from a pre-trained Gaussian Mixture Model (GMM). By dynamically updating the weights of different GMM models based on the latest forecasts, these scenarios are sampled from the GMM to represent fluctuations in DER generation and load demand. In some embodiments, as the power grid is generally large, the power grid is divided into a plurality of clusters containing one or more DERs that caters to common load, and a plurality of scenarios are generated for each cluster separately. Thereafter, scenarios for all the clusters are utilized for generating the plurality of representative scenarios, forecasting DER's generation and load demand in the power grid over a prediction time horizon. It may be noted that the models, for example, Gaussian models, that generates multiple scenarios for DER's generation and the load for each cluster is trained on historical data for the associated cluster.

Upon generating the multiple representative scenarios, the method 100, at step 120, determine control schedules for reconfigurable parameters of the power grid by employing an optimization technique that minimizes expected curtailment of the DERs while satisfying all generated scenarios as constraints. The reconfigurable parameters include at least one of renewable energy generation schedules of the DERs, tap position schedule of the voltage regulators, and status schedules of the switch controllers. The optimization of switch controller schedules ensures radiality constraints in the distribution network, preventing unintended meshed network configurations, reduces circulating currents, and maintain efficient fault isolation and protection coordination. In power distribution networks, radiality refers to a network configuration in which all distribution feeders (lines or cables) emanate from a single point and there is only one path for electricity to flow from the source to the load. In some embodiments, the reconfigurable parameters also include tie switch statuses and sectionalizing switch statuses, enabling dynamic feeder reconfiguration to optimize power flow, enhance operational hosting capacity, and maintain grid stability by preventing overloads and voltage violations and imbalances.

In some embodiments, minimizing expected curtailment of DERs accounts for voltage regulation constraints, thermal limits, and network topology constraints, ensuring that DERs integration does not lead to voltage instability, line congestion, or thermal overloading, thereby maintaining power quality and infrastructure safety. Accordingly, optimization technique identifies control schedules that ensures maximum renewable utilization within operational limits of the power, preventing any instability and power quality issues.

In some embodiments, the method 100 uses/employes Surrogate Lagrangian Relaxation (SLR) with temporal decomposition for determining control schedules for reconfiguration parameters of the power grid. SLR accelerates optimization while maintaining solution quality. The determined control schedules for reconfiguring the power grid facilitates in effectively integrate the DER into the power and load balance in the power grid, while ensuring that the voltage levels are withing acceptable limits within the grid.

Upon determining the control schedules for reconfiguring parameters of the power grid, the method 100, at a step 130, translates the optimized control schedules into executable commands for one or a combination of the DERs, voltage regulators, and switch controllers to control the power grid to manage the power generation and load across the power grid for the predicted horizon. In some embodiments, the executable commands for voltage regulators include incremental tap adjustments optimized using a linearized three-phase power flow model, ensuring voltage deviations are minimized while maintaining balance across all phases in the distribution system. Based on the generated control commands, the method 100, at a step 140, controls, via a controller, the power grid for the prediction time horizon to utilize the DER power generation and the load demand.

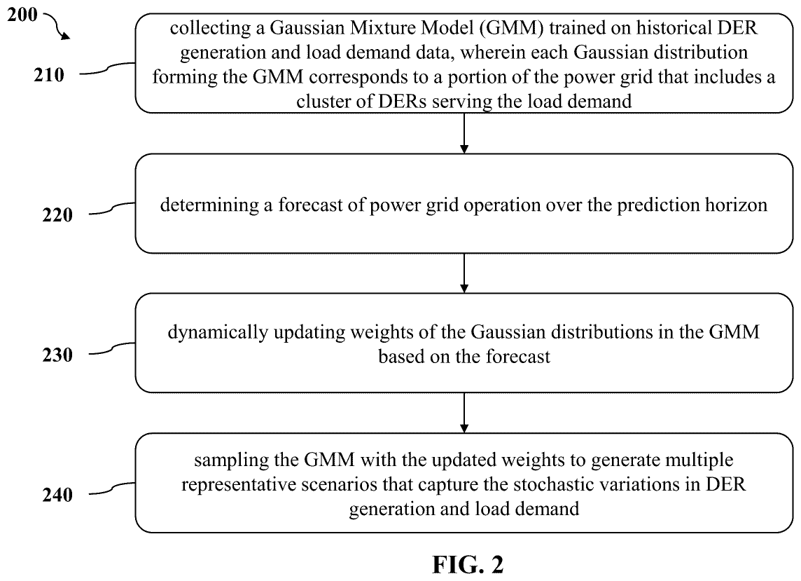

Referring to FIG. 2, a method 200 for generating multiple representative scenarios is shown according to an example embodiment of the disclosure. The method 200 includes a step 210 of collecting/using/employing a Gaussian Mixture Model (GMM) trained on historical DER generation and load demand data for the power grid. A Gaussian Mixture Model (GMM) is a weighted sum of multiple Gaussian (normal) distributions. In the embodiment, each Gaussian distribution forming the GMM corresponds to a portion of the power grid that includes a cluster of DERs serving the common load demand. Weight of each gaussian distribution corresponding to each cluster is determined dynamically and updated dynamically. For example, the weights can be set differently for various day types or weather conditions, and updated as the day or weather type evolves. GMM is a model based on time series data that exhibits complex, multimodal distributions, helping to predict future values by understanding the underlying patterns in the data.

Upon collecting the GMM or otherwise, the method 200 includes a step 220 of determining a forecast of power grid operation over the predicted horizon, for example, 24 hour time period. The power grid operation can be a weather type, day type, system total generation/load, or predicted average generation outputs and load demands. Upon determining the forecast of the power grid operation over the predicted horizon, the method 200 includes a step 230 of dynamically updating weights of the gaussian distributions in the GMM based on the forecast. Different power grid operation can have pre-set weight combination determined through training using historical data. The method 200 at step 240 uses the determined updated weights of the gaussian distributions of the clusters in GMM to generate multiple representative scenarios to capture the stochastic variations in DER generation and load demand. In some embodiments, the Gaussian Mixture Model (GMM) includes separate gaussian distributions for DER generation and load demand, each modeled independently. In such a case, scenarios are generated by sampling the DER generation distribution and the load demand distribution independently to produce multiple representative scenarios for forecasting power grid operation.

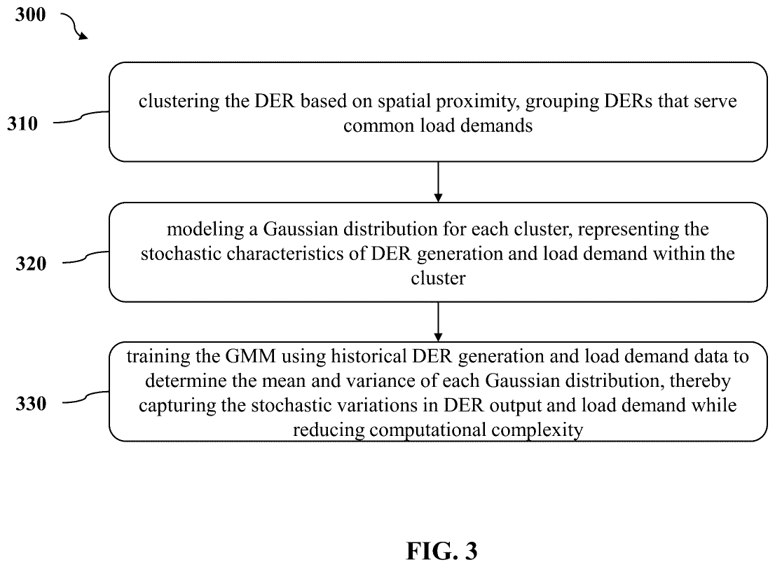

Referring to FIG. 3, an example method 300 for training the GMM model is shown. The method 300 includes a step 310 of clustering the DERs based on spatial proximity that serve common load demands. As the power grid, generally, spans over a large geographical area having sub-areas in which the environmental conditions, for example, temperature, sunlight, wind, etc. vary, resulting into variations in DER generation and load demand. To account for these variations between different sub-regions or cluster, the clustering of the DERs is performed based on proximity to each other and the load served by the DERs.

The method 300 further includes a step 320 of modeling Gaussian distribution for each cluster based on the historical data representing the stochastic characteristics of DER generation and load demand within the cluster. In an embodiment the Gaussian distribution of DER generation and the load demand are modeled independent of each other for a cluster. In some embodiments, a combined Gaussian distribution for DER generation and the load demand is modeled for a cluster. Thereafter, the method 300 includes a step 330 at which the GMM is trained using historical DER generation and load demand data to determine the mean and variance of each Gaussian distribution, thereby capturing the stochastic variations in DER output and load demand while reducing computational complexity.

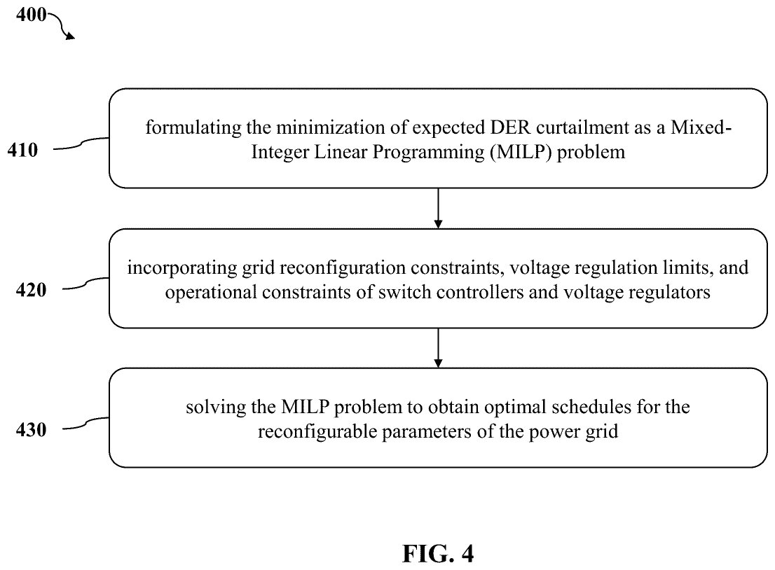

Referring to FIG. 4, an example method 400 for determining the control schedules for reconfiguring parameters of the power grid by solving an optimization technique is shown. The method 400 includes a step 410 of formulating the minimization of the expected DER curtailment as Mixed-Integer Linear Programming (MILP) problem for each of the determined scenario over the predicted time horizon. The representative scenarios are incorporated as the constraints such that the determined control schedules are valid of each of the representative scenario to minimize the DER curtailment and maximize the operational hosting capacity of DERs. The method 400 also includes a step 420 of incorporating various operational constraints into the MILP problem. The various operational constraint includes grid reconfiguration constraints, voltage regulation limit, and operational constraints of the switch controllers and voltage regulators. By incorporating the operational constraints as well as the representative scenarios as the constraints for MILP problem with the objective of minimizing the DERs curtailment, a stochastic operational hosting capacity optimization model (S-HC) is formulated/determined.

In some embodiments, the grid reconfiguration constraints include one or more of switching constraints, power flow constraints, network topology constraints, voltage constraints, load flow balance constraints, contingency constraints, transmission line flow distribution constraints. The switching constraints ensure that the switching decisions are selected such that the overall topology of the grid is satisfied. For example, if one line is disconnected, power flow on that line is to be zero, and connected components needs to satisfy power balance. Power flow constraints ensures that the grid's power flow obeys the network's physical laws (e.g., Kirchhoff's Voltage and Current Laws). For any reconfiguration the power flow satisfies constraints on each component. For example, the power flow between two buses is limited by the transmission line capacity. This ensures that no transmission line is overloaded when the grid is reconfigured. Operational constraints of the switch controller and the voltage regulators is such that daily operational limit remains below the associated maximum allowed operational limit

The method 400 also includes a step 430 at which a processor solves the MILP problem i.e., stochastic hosting capacity optimization model (S-HC) to obtain optimal control schedules for the reconfigurable parameters of the power grid. In some embodiments, the method 400 uses a Surrogate Lagrangian Relaxation (SLR) algorithm with temporal decomposition to solve the MILP problem i.e., stochastic operational hosting capacity optimization model (S-HC) to obtain optimal control schedules for reconfigurable parameters. Use of SLR accelerates computation and enable real-time operational decisions.

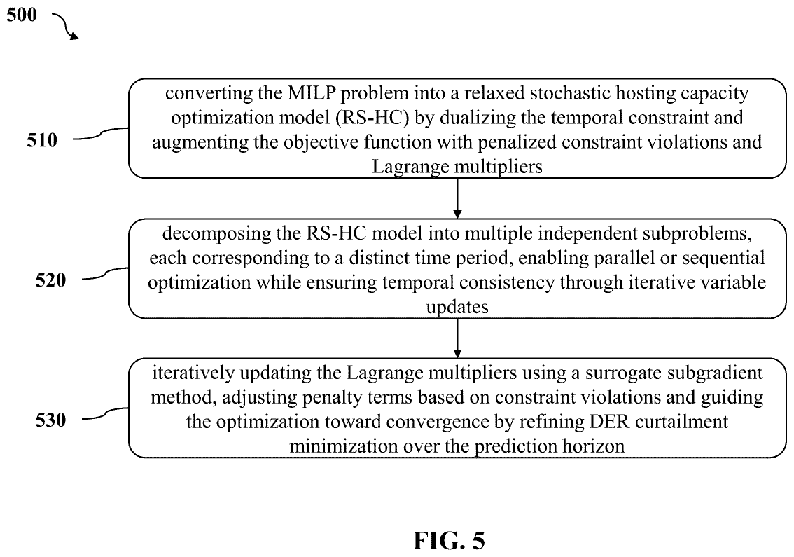

Referring to FIG. 5, a method 500 for solving the MILP problem i.e., stochastic operational hosting capacity optimization model (S-HC) using a Surrogate Lagrangian Relaxation (SLR) algorithm with temporal decomposition is disclosed. The method 500 includes at step 510 at which a processor dualize the temporal constraints of MILP problem and augment the objective function of MILP by incorporating the product of the Lagrange multipliers and the temporal daily operation and maximum time step constraints. By incorporating the Lagrange multipliers and by augmenting the objective function with penalized constraint violations, the MILP problem i.e., stochastic operational hosting capacity optimization model (S-HC) is converted into a relaxed stochastic operational hosting capacity optimization model (RS-HC). In some embodiments, the penalized constraint violations include maximum number of allowed switch operations, maximum number of allowed tap position changes, maximum time steps for bus over voltage violations, and maximum time steps for bus under voltage violations.

Thereafter, the method 500 includes a step 520 at which the RS-HC problem is decomposed into multiple independent subproblems, each corresponding to a distinct time period within the predicted time horizon. This enables parallel or sequential optimization while ensuring temporal consistency through iterative variable updates. A sub-problem for sub-period at an iteration level is formulated by fixing the variables in other subproblems to the values obtained from the previous iteration. The method 500 also includes a step 530 at which the Lagrange multipliers are iteratively updated using a surrogate subgradient method and penalty terms are adjusted based on constraint violations to guide the optimization toward convergence by refining DER curtailment minimization over the prediction horizon. In this manner, by solving stochastic operational hosting capacity optimization model (S-HC) using a Surrogate Lagrangian Relaxation (SLR), control schedules for reconfiguring parameters of the power grid is determined, which are then used to control the power grid during the scheduling horizon so that the DERs energy generation is maximized.

### Example Implementation

An example implementation for determining the renewable stochastic operational hosting capacity of power grid over a given scheduling horizon and control of the power grid is disclosed. The implementation details about integration of network reconfiguration with the maximization of renewable energy utilization, i.e., minimization of DERs curtailment. The example implementation is described for a three phase power distribution system. At first a processor determines the three phase power flow model incorporating the voltage regulator. In the example power distribution system i.e., the power grid ε is the set of all branches, [symbol] is the set of all buses, ε^{r} is the set of branches that have voltage regulators, ε^{s} is the sets of branches that have switches, [symbol] is the set of buses which have DERs. [symbol] is the set of substations, and [symbol] ₃ is the set of three-phase buses.

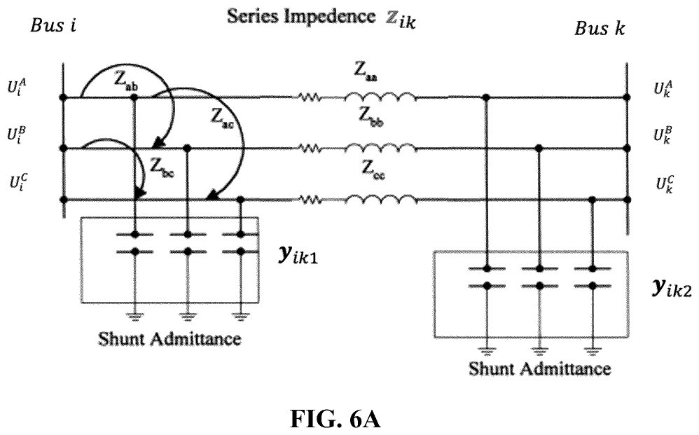

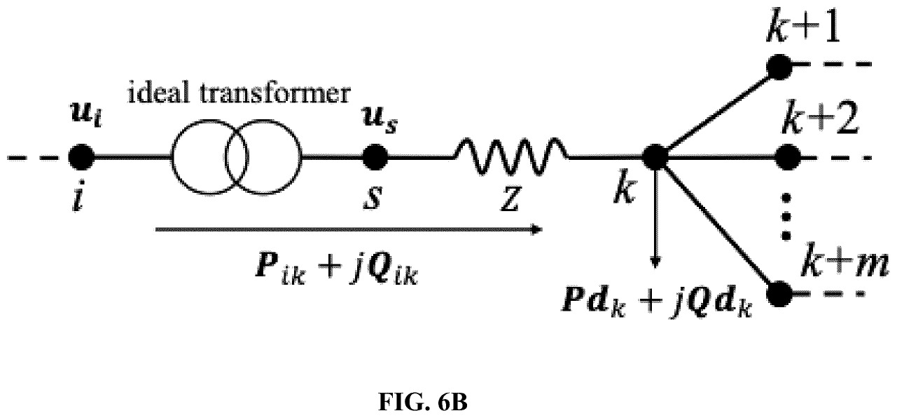

As illustrated in FIG. 6A, for determining the three phase power flow model, a line branch between bus i, and bus k are modelled as a series impedance zᵢₖ and two shunt admittances yᵢₖ₁ and yᵢₖ₂. Due to limited magnitudes of shunt admittances, in the embodiment, those matrices are treated as zero ones. zᵢₖ=rᵢₖ+jxᵢₖ ∈ [symbol] are the three-phase impedance matrix of branch (i, k), and rᵢₖ and xᵢₖ are the resistance and reactance matrices of branch (i, k), respectively.

For each branch (i, k)∈ε, the voltage drop is:

$${u}_{k} = {u}_{i} - {z}_{i k} [ ( {P}_{i k} - {Q}_{i k} ) ∅ {u}_{i} ]$$

(1)
where

$${u}_{i} = {[ {V}_{i}^{A} , {V}_{i}^{B} , {V}_{i}^{C} ]}^{T} , {u}_{k} = {[ {V}_{k}^{A} , {V}_{k}^{B} , {V}_{k}^{C} ]}^{T} ∈ {ℂ}^{3 \times 1}$$

are the three-phase voltage vector of bus i and bus k, and

$${V}_{i}^{φ}$$

is the voltage at bus i and phase φ. Pᵢₖ, Qᵢₖ ∈ [symbol]
are the three-phase active and reactive power vector of branch (i, k).

Assuming that the voltage magnitudes between the phases are nearly balanced, the processor multiply both sides of (1) by its conjugate to obtain:

$${\vert {u}_{k} \vert}^{2} = {\vert {u}_{i} \vert}^{2} - 2 ( {\tilde{r}}_{i k} {P}_{i k} + {\tilde{x}}_{i k} {Q}_{i k} ) + {c}_{i k}^{u} ( {P}_{ik} , {Q}_{i k} ) \qquad ( 2 )$$

where \tilde{r}ᵢₖ=Re{aa^{H}}⊗rᵢₖ+Im{aa^{H}}⊗xᵢₖ is the equivalent resistance matrix, \tilde{x}ᵢₓ=Re{aa^{H}}⊗xᵢₖ-Im{aa^{H}}⊗rᵢₖ is the equivalent reactance matrix, a=[1, e^{-jπ/3}, e^{jπ/3}], and

$${c}_{i k}^{u} ( {P}_{ik} , {Q}_{i k} )$$

is the high-order linear approximation.

Consider a three-phase, wye-wye solidly grounded transformer or voltage regulator situated in branch (i,k), which, in some embodiments, is equivalently represented by an ideal transformer in series with an impedance zᵢₖ, as illustrated in FIG. 6B. In this model, bus s is a virtual node between bus i and bus k, connected to the secondary side of the ideal transformer. Here, z represents the combined impedance of the voltage regulator and the branch. Accordingly:

$${U}_{s}^{φ} = {η}_{i k}^{2} {U}_{i}^{φ} = {( {η}_{i k} + {τ}_{i k} Δ {η}_{i k} )}^{2} {U}_{i}^{φ}$$

$${U}_{i}^{φ} = {\vert {V}_{i}^{φ} \vert}^{2}$$

is the squared voltage magnitude of bus i and phase φ, ηᵢₖ and ηᵢₖ denotes the turn ratio of the voltage regulator and its minimum setting, Tik represents the tap position, Δηᵢₖ is the incremental turn ratio.

To obtain a linear formulation of voltage regulators, the processor first applies Special Ordered Set type 1 (SOS1) to model the voltage relationship between bus i and bus s as:

$${φ}_{s}^{φ} = {U}_{i}^{φ} \cdot {\sum }_{m = 1}^{{M}_{ik}} {x}_{i k}^{m} {w}_{i k}^{m} \qquad ( 3 )$$

$${\sum }_{m = 1}^{{M}_{ik}} {x}_{i k}^{m} \cdot {w}_{i k}^{m} = {η}_{ik}^{2} , {\sum }_{m = 1}^{{M}_{ik}} {x}_{i k}^{m} \cdot m = {τ}_{ik} , {\sum }_{m = 1}^{{M}_{ik}} {x}_{i k}^{m} = 1. \qquad ( 4 )$$

where Mᵢₖ is the total number of taps, and

$${x}_{ik}^{m} , {w}_{i k}^{m}$$

are a binary variable and its associated non-negative weight, respectively.

Then, the processor defines a new variable

$${y}_{i k}^{m} = {U}_{i}^{φ} \cdot {x}_{i k}^{m}$$

and apply the big-M method to relax constraint (3) as:

$$0 \leq {y}_{i k}^{m} \leq M \cdot {x}_{i k}^{m} , 0 \leq {U}_{i}^{φ} - {y}_{i k}^{m} \leq M \cdot ( 1 - {x}_{i k}^{m} ) \qquad ( 5 )$$

Where M is a sufficient big number.

A similar procedure, in some embodiments, is applied to the power flow balance of branch (i, k), which gives:

$${P}_{i k} = {\sum }_{j ∈ 𝒩 ( k )} {P}_{k j} + P {d}_{k} + {c}_{i k}^{p} ( P , Q ) \qquad ( 6 )$$

$${Q}_{i k} = {\sum }_{j ∈ 𝒩 ( k )} {Q}_{k j} + Q {d}_{k} + {c}_{i k}^{q} ( P , Q )$$

where Pᵢₖ, Qᵢₖ are the active and reactive power flow of branch (i, k), Pdₖ, Qdₖ are the active and reactive load at bus k,

$${c}_{i k}^{p} ( P , Q ) , {c}_{i k}^{p} ( P , Q )$$

are the higher-order linear approximation of active and reactive loss.

### Deterministic Operational Hosting Capacity Optimization Model

The processor, based on the power flow model, determines/forms a deterministic operational hosting capacity optimization model for DERs with the objective to maximize the total active generation capacity of all Distributed Energy Resources (DERs):

$$max {\sum }_{i ∈ 𝒢} {\sum }_{t ∈ 𝒯} {\sum }_{φ ∈ {ψ}_{i}} {Pg}_{i , t}^{φ}$$

where

$$P {g}_{i , t}^{φ}$$

is the active power of DER on bus i at time t and phase φ. ψᵢ is the set of phases at bus i. [symbol] is the set of time steps within the scheduling horizon.

It may be noted that the maximizing renewable generations is equivalent to minimizing the total active generation curtailment of all DERs which is chosen as the objective. To reduce the frequency of switch and transformer or voltage regulator operations while maximizing renewable generation i.e, minimizing DERs curtailment, the processor includes corresponding operational costs along with operational constraints in the objective function as well.

### 1). Objective Function:

$$\begin{matrix}a & \\ min {\sum }_{t ∈ 𝒯} ( {\sum }_{i ∈ 𝒢} {\sum }_{φ ∈ {ψ}_{i}} ( \text{?} - {Pg}_{i , t}^{φ} ) + {\sum }_{( i , k ) ∈ {ε}^{s}} {ω}^{s} {γ}_{ik , t} + {\sum }_{( i , k ) ∈ {ε}^{r}} {ω}^{r} {ρ}_{ik , t} ) . & ( 7 )\end{matrix}$$

where

$$\text{?} and {Pg}_{i , t}^{φ}$$

are the predicted and scheduled active powers of XC switches and voltage regulators, γ_{ik,t}, ρ_{ik,t} are the operation statuses of switch/voltage regulator on branch (i, k) at time t.

### 2). DER Output Constraints:

$${Pg}_{i , t}^{φ} = {ζ}_{i , t}^{φ} \cdot \text{?} , 0 \leq {ζ}_{i , t}^{φ} \leq 1$$

$${( {Pg}_{i , t}^{φ} )}^{2} + {( {Qg}_{i , t}^{φ} )}^{2} \leq {( {Sg}_{i}^{φ} )}^{2}$$

$$∀ i ∈ 𝒢 , ∀ t ∈ 𝒯 , ∀ φ ∈ {ψ}_{i}$$

where

$${ζ}_{i , t}^{φ}$$

is the efficiency variable of DER on phase φ of bus i at time t,

$${Qg}_{i , t}^{φ}$$

is the reactive power of DER on phase φ of bus i at time t,

$${Sg}_{i , t}^{φ}$$

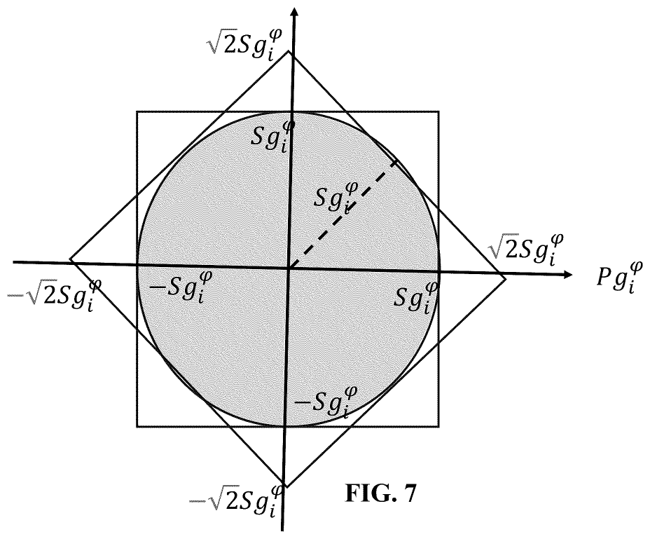

is the installed capacity of DER on phase φ of bus i. The active and reactive output constraint is a circular function of installed capacities. As demonstrated in FIG. 7, this kind of circular constraints are simplified by using two rectangular constraints to obtain following linear constraints on DERs:

$${Pg}_{i , t}^{φ} = {ζ}_{i , t}^{φ} \cdot \text{?} , 0 \leq {ζ}_{i , t}^{φ} \leq 1 \qquad ( 8 )$$

$$- \sqrt{2} {Sg}_{i}^{φ} \leq {Pg}_{i , t}^{φ} + {Qg}_{i , t}^{φ} \leq \sqrt{2} {Sg}_{i , t}^{φ} ,$$

$$- \sqrt{2} {Sg}_{i}^{φ} \leq {Pg}_{i , t}^{φ} - {Qg}_{i , t}^{φ} \leq \sqrt{2} {Sg}_{i}^{φ} ,$$

$$- {Sg}_{i}^{φ} \leq {Pg}_{i , t}^{φ} \leq {Sg}_{i}^{φ} ,$$

$$- {Sg}_{i}^{φ} \leq {Qg}_{i , t}^{φ} \leq {Sg}_{i}^{φ} ,$$

$$∀ i ∈ 𝒢 , ∀ t ∈ 𝒯 , ∀ φ ∈ {ψ}_{i}$$

### 3). Branch Power Flow Balance and Voltage Drop Constraints:

$${P}_{ik , t}^{φ} = {\sum }_{j ∈ \text{?} ( k )} {P}_{kj , t}^{φ} + {Pd}_{k , t}^{φ} - {Pg}_{k , t}^{φ} \qquad ( 9 )$$

$${P}_{ik , t}^{φ} = {\sum }_{j ∈ \text{?} ( k )} {Q}_{kj , t}^{φ} + {Qd}_{k , t}^{φ} - {Qg}_{k , t}^{φ}$$

$$∀ k ∈ \text{?} , ∀ t ∈ 𝒯 , ∀ φ ∈ {ψ}_{i}$$

where [symbol] (k) is the set of downstream buses connected to bus k. Here the processor neglects the higher-ordered term in (6).

For branches without a transformer or voltage regulator, power flow induced voltage drops, in some embodiments, are represented as:

$${U}_{k , t}^{φ} \leq {U}_{i , t}^{φ} - 2 ( {\tilde{r}}_{ik}^{φ} {P}_{ik , t} + {\tilde{x}}_{ik}^{φ} {Q}_{ik , t} ) + M ( 1 - {α}_{ik , t} ) \qquad ( 10 )$$

$${U}_{k , t}^{φ} \geq {U}_{i , t}^{φ} - 2 ( {\tilde{r}}_{ik}^{φ} {P}_{ik , t} + {\tilde{x}}_{ik}^{φ} {Q}_{ik , t} ) - M ( 1 - {α}_{ik , t} )$$

$$∀ ( i , k ) ∈ ε / {ε}^{r} , ∀ t ∈ 𝒯 , ∀ φ ∈ {ψ}_{i}$$

where α_{ik,t} is a binary indicator variable which equals 1 if branch (i, k) are connected at time t. Again, the processor neglects the high-order term in (2).

For branches with a transformer or voltage regulator, the voltage drops is described as:

$${U}_{s , t}^{φ} = {U}_{i , t}^{φ} \cdot {\sum }_{m = 1}^{{M}_{ik}} {x}_{ik}^{m} {w}_{ik}^{m} \qquad ( 11 )$$

$${\sum }_{m = 1}^{{M}_{ik}} {x}_{ik}^{m} \cdot {w}_{ik}^{m} = {η}_{ik}^{2} , {\sum }_{m = 1}^{{M}_{ik}} {x}_{ik}^{m} \cdot m = {τ}_{ik} , {\sum }_{m = 1}^{{M}_{ik}} {x}_{ik}^{m} = 1$$

$$0 \leq {y}_{ik}^{m} \leq M \cdot {x}_{ik}^{m} , 0 \leq {U}_{i}^{φ} - {y}_{ik}^{m} \leq M \cdot ( 1 - {x}_{ik}^{m} )$$

$${U}_{k , t}^{φ} \leq {U}_{s , t}^{φ} - 2 ( {\tilde{r}}_{ik}^{φ} {P}_{ik , t} + {\tilde{x}}_{ik}^{φ} {Q}_{ik , t} ) + M ( 1 - {α}_{ik , t} )$$

$${U}_{k , t}^{φ} \geq {U}_{s , t}^{φ} - 2 ( {\tilde{r}}_{ik}^{φ} {P}_{ik , t} + {\tilde{x}}_{ik}^{φ} {Q}_{ik , t} ) - M ( 1 - {α}_{ik , t} )$$

$$∀ ( i , k ) ∈ {ε}^{r} , ∀ t ∈ 𝒯 , ∀ φ ∈ {ψ}_{i}$$

### 4). Voltage Magnitude and Imbalance Constraints:

$${U}_{i , t}^{φ} = {U}_{ref} , ∀ i ∈ 𝒮 \qquad ( 12 )$$

$$\underline{{U}_{i}} \leq {U}_{i , t}^{φ} \leq {\overline{U}}_{i} , ∀ i ∈ 𝒩 / 𝒮$$

$$- ϵ \leq \frac{{U}_{i , t}^{φ} - {\tilde{U}}_{i , t}}{{\tilde{U}}_{i , t}} \leq ϵ , {\tilde{U}}_{i , t} = \frac{1}{3} {\sum }_{φ ∈ {ψ}_{i}} {U}_{i , t}^{φ} , ∀ i ∈ {𝒩}_{3}$$

$$∀ t ∈ 𝒯 , ∀ φ ∈ {ψ}_{i}$$

where U_{ref} is the reference squared voltage for substation buses. Ũ_{i,t} is the average squared voltage magnitude of bus i at time t. Ūᵢ and Uᵢ are the upper and lower limits for squared voltage magnitudes of bus i. The third equation is used to regulate the imbalance level for all three-phase buses. ϵ is the voltage imbalance limit factor.

### 5). Voltage Violation Duration Limits:

In addition to the instantaneous voltage magnitude limits, the processor also incorporates the voltage violation duration limits, as shown in FIG. 7, to capture dynamic information, expressed as:

$${\overline{U}}_{i} \cdot {\overline{y}}_{i , t}^{φ} \leq {U}_{i , t}^{φ} \leq {\overline{U}}_{i} + M \cdot {\overline{y}}_{i , t}^{φ} - {\overline{ε}}_{i , t}^{φ} \qquad ( 13 )$$

$$\underline{{U}_{i}} \cdot ( 1 - {\underline{y}}_{i , t}^{φ} ) \leq {U}_{i , t}^{φ} \leq \underline{{U}_{i}} + M \cdot ( 1 - {\underline{y}}_{i , t}^{φ} ) - {\underline{ε}}_{i , t}^{φ}$$

$$∀ i ∈ 𝒩 , ∀ t ∈ 𝒯 , ∀ φ ∈ {ψ}_{i}$$

$${\sum }_{t = l - d}^{l} {\overline{y}}_{i , t}^{φ} \leq d , \qquad ( 14 )$$

$${\sum }_{t = l - d}^{l} {\underline{y}}_{i , t}^{φ} \leq d ,$$

$$∀ i ∈ 𝒩 , ∀ φ ∈ {ψ}_{i} , ∀ l ∈ {𝒯}_{d}$$

where

$${\overline{y}}_{i , t}^{φ} and {\underline{y}}_{i , t}^{φ}$$

are binary variables to represent voltage upper and lower limit violation statuses. d is s the maximum allowed number of steps for continuous voltage limit violation.

$${\overline{ε}}_{i , t}^{φ} and {\underline{ε}}_{i , t}^{φ}$$

are required reserved voltage margins for upper and lower limit violations. (14) are constraints limiting multiple time steps. [symbol] is the set of time steps that need checking voltage violation durations.

### 6) Branch Thermal Capacity Constraints:

$${( {P}_{ik , t}^{φ} )}^{2} + {( {Q}_{ik , t}^{φ} )}^{2} \leq {{α}_{ik , t} ( {S}_{ik}^{max} )}^{2}$$

where

$${S}_{ik}^{max}$$

is the thermal capacity of branch (i,k), α_{ik,t} is a binary variable to represent the branch closed/open status, if 1 the branch is closed, otherwise open.

Similarly, according to FIG. 7, this thermal constraints is simplified with the following constraints:

$$\begin{matrix}- \sqrt{2} {α}_{ik , t} {S}_{ik}^{max} \leq {P}_{ik , t}^{φ} + {Q}_{ik , t}^{φ} \leq \sqrt{2} {α}_{ik , t} {S}_{ik}^{max} \\ - \sqrt{2} {α}_{ik , t} {S}_{ik}^{max} \leq {P}_{ik , t}^{φ} - {Q}_{ik , t}^{φ} \leq \sqrt{2} {α}_{ik , t} {S}_{ik}^{max} \\ - {α}_{ik , t} {S}_{ik}^{max} \leq {P}_{ik , t}^{φ} \leq {α}_{ik , t} {S}_{ik}^{max} \\ - {α}_{ik , t} {S}_{ik}^{max} \leq {Q}_{ik , t}^{φ} \leq {α}_{ik , t} {S}_{ik}^{max}\end{matrix} \qquad ( 15 )$$

### 7). Radiality Constraints:

The distribution system is required to operate using radial configuration.

$${\sum }_{( i , k ) ∈ ε} {α}_{ik , t} = N - S$$

$${β}_{ik , t} + {β}_{ki , t} = {α}_{ik , t}$$

$${\sum }_{k ∈ ℕ ( i )} {β}_{ik , t} = 1 , \qquad ( 16 )$$

$$∀ i ∈ 𝒩 / 𝒮$$

$${β}_{ik , t} = 0 , \qquad ( 17 )$$

$$∀ i ∈ 𝒮$$

where N, S are the total number of all buses and substation buses, β_{ik,t} is a binary variable that equals 1 if k is the upstream bus of i.

### 8). Switch and Voltage Regulator Operation Constraints:

$${γ}_{ik , t} \geq {α}_{ik , t} - {α}_{ik , t - 1}$$

$${γ}_{ik , t} \geq {α}_{ik , t - 1} - {α}_{ik , t}$$

$${ρ}_{i k , t} \geq {τ}_{ik , t} - {τ}_{ik , t - 1}$$

$${ρ}_{ik , t} \geq {τ}_{ik , t - 1} - {τ}_{ik , t}$$

$${\sum }_{t ∈ 𝒯} {γ}_{ik , t} \leq {γ}_{ik}^{max} \qquad ( 18 )$$

$${\sum }_{t ∈ 𝒯} {ρ}_{ik , t} \leq {ρ}_{ik}^{max} \qquad ( 19 )$$

where

$${γ}_{ik}^{max} ,$$

$${ρ}_{ik}^{max}$$

are the daily operation limits for switch and voltage regulator on branch (i, k).

### Stochastic Operational Hosting Capacity Optimization Model

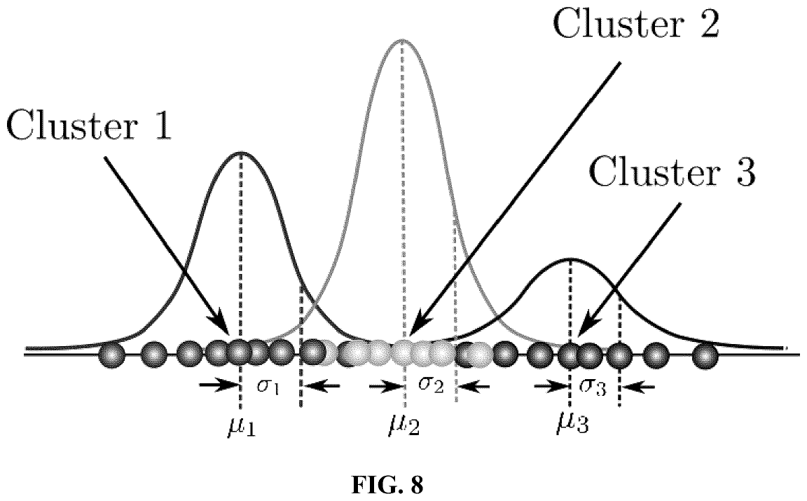

For building the Stochastic Operational Hosting Capacity Optimization Model, the processor, at first applies a Gaussian Mixture Model (GMM) to tackle the uncertainty of DER generations and load demands. As demonstrated in FIG. 8, a GMM is a probabilistic model that assumes all the data points are generated from a mixture of a finite number of Gaussian distributions with unknown parameters.

As shown in (20), the probabilistic density function (PDF) of DER generation [symbol] at time t is given by,

$$P D {F}_{t} ( \text{?} ) = {\sum }_{i = 1}^{K} {φ}_{i} N ( \text{?} \vert {μ}_{i} , {\sum }_{i} ) , {\sum }_{i = 1}^{K} {ϕ}_{i} = 1 \qquad ( 20 )$$

$$N ( \text{?} \vert {μ}_{i} , {\sum }_{i} ) = \frac{exp ( - \frac{1}{2} {( \text{?} - {μ}_{i} )}^{𝒯} {\sum }_{i}^{- 1} ( \text{?} - {μ}_{i} ) )}{\sqrt{{( 2 π )}^{K} \vert {\sum }_{i} \vert}}$$

where K is the number of mixture components, μᵢ, Σᵢ are the expectation and covariance matrix of component i, φᵢ is the weight coefficient of component i. [symbol] is a set of generation outputs, or a set of generation ratios relative to the maximum generation capacity.

The PDF of load demand is defined in a similar manner. The variables to be predicted are either a set of load demands or a set of loading ratios relative to the maximum load demand.

After the processor receives the PDF of all DER generation and load demands, it generates multiple scenarios for each time period within scheduling horizon. Each scenario contains predicted generation outputs for each DER and load consumption for each load.

In this embodiment, the processor assumes an equal probability distribution across all scenarios. However, in some embodiments, different probabilities, in some embodiments, is assigned to different scenarios within the multiple scenarios.

For clarity, all decision variables and parameters are divided into two groups and represented using vectors as follows.

$$a : \{ {P ℊ}_{i , t}^{φ} , {Q ℊ}_{i , t}^{φ} , \text{?} , {Pd}_{k , t}^{φ} , {Qd}_{k , t}^{φ} , {P}_{ik , t}^{φ} , {Q}_{ik , t}^{φ} , {U}_{k , t}^{φ} , {\tilde{U}}_{i , t} , {ζ}_{i , t}^{φ} , {\overline{y}}_{i , t}^{φ} , {\underline{y}}_{i , t}^{φ} \} \qquad ( 21 )$$

$$b : \{ {x}_{ik , t}^{m} , {y}_{ik , t}^{m} , {α}_{ik , t} , {β}_{ik , t} , {γ}_{ik , t} , {τ}_{ik , t} , {ρ}_{ik , t} \}$$

Among the variables, a varies with the operational scenario and changes over time, whereas b varies only with time.

Accordingly, the stochastic operational hosting capacity optimization model (S-HC) is formulated as follows:

$$min {\sum }_{t ∈ 𝒯} ( \begin{matrix}\frac{1}{\vert 𝒞 \vert} {\sum }_{c ∈ 𝒞} {\sum }_{i ∈ 𝒢} {\sum }_{φ ∈ {ψ}_{i}} ( \text{?} - {P ℊ}_{i , t}^{φ , c} ) \\ + {\sum }_{( i , k ) ∈ {ε}^{s}} {ω}^{s} {γ}_{ik , t} \\ + {\sum }_{( i , k ) ∈ {ε}^{r}} {ω}^{r} {ρ}_{ik , t}\end{matrix} ) \qquad ( 22 )$$

$$s . t . ( 8 ) - ( 19 ) ,$$

$$a \to {α}^{c} ,$$

$$∀ c ∈ 𝒞 .$$

where [symbol] is the set of scenarios generated by (20). All decision variables a is expanded to include an additional dimension for scenario and is denoted as a^{c}.

S-HC is a mixed integer linear program problem.

### Solution Methodology for Stochastic Operational Hosting Capacity Optimization

Upon determining/formulating the stochastic operational hosting capacity optimization model (S-HC), the processor solves the S-HC to determine control schedules for reconfiguring parameters of the power grid. For so doing, the processor uses/employs a temporal decomposition approach with the Surrogate Lagrangian Relaxation (SLR) algorithm to accelerate the solving time for stochastic operational hosting capacity optimization model, S-HC. For so doing, the scheduling horizon [symbol] is divided into a set of disjoint subhorizons [symbol] , where j∈ [symbol] , such that [symbol] = [symbol] , and [symbol] ∩ [symbol] =Ø, for j1, j2∈ [symbol] , and j1≠j2.

(1). Dualization: For solving the stochastic operational hosting capacity optimization model, S-HC using SLR, the processor, at first, dualizes the temporal daily operation constraint (19) and the voltage violation duration limit (14) and augment the objective function of S-HC by incorporating the product of the Lagrange multipliers and the temporal constraints, and derives a relaxed stochastic operational hosting capacity optimization model (RS-HC) as:

$$min {\sum }_{j ∈ 𝒥} ( \begin{matrix}\frac{1}{\vert 𝒞 \vert} {\sum }_{c ∈ 𝒞} {\sum }_{i ∈ 𝒢} {\sum }_{t ∈ {𝒯}_{j}} {\sum }_{φ ∈ {ψ}_{i}} ( \text{?} - {P ℊ}_{i , t}^{φ , c} ) \\ + {\sum }_{c ∈ 𝒞} {\sum }_{i ∈ 𝒢} {\sum }_{t ∈ {𝒯}_{j} ⋂ {𝒯}_{d}} {\sum }_{φ ∈ {ψ}_{i}} {{\sum }^{t}}_{k = t - d} ( {\overline{y}}_{i , t}^{φ , c} {\overline{λ}}_{i , t}^{φ , c} + {\underline{y}}_{i , t}^{φ , c} {\underline{λ}}_{i , t}^{φ , c} ) \\ - {\sum }_{c ∈ 𝒞} {\sum }_{i ∈ 𝒢} {\sum }_{t ∈ {𝒯}_{j} ⋂ {𝒯}_{d}} {\sum }_{φ ∈ {ψ}_{i}} ( {\overline{λ}}_{i , t}^{φ , c} + {\underline{λ}}_{i , t}^{φ , c} ) d \\ + {\sum }_{( i , k ) ∈ {ε}^{s}} ( ( {λ}_{ik} + {ω}^{s} ) {\sum }_{t ∈ {𝒯}_{j}} {γ}_{ik , t} - {λ}_{ik} {γ}_{ik}^{max} ) \\ + {\sum }_{( i , k ) ∈ {ε}^{r}} ( ( {ν}_{ik} + {ω}^{r} ) {\sum }_{t ∈ {𝒯}_{j}} {ρ}_{ik , t} - {ν}_{ik} {ρ}_{ik}^{max} )\end{matrix} ) \qquad ( 23 )$$

$$s . t . ( 8 ) - ( 13 ) ,$$

$$( 15 ) - ( 18 ) ,$$

$$a \to {a}^{c} ,$$

$$∀ t ∈ {𝒯}_{j} ,$$

$$∀ c ∈ 𝒞 ,$$

$$∀ j ∈ 𝒥$$

where [symbol] is a subset of time horizon [symbol] , [symbol] is the set of subproblems. λᵢₖ and vᵢₖ are the Lagrange multipliers for the temporal daily operation constraint (19), and

$${\overline{λ}}_{i , k}^{φ , c} ,$$

$${\underline{λ}}_{i , k}^{φ , c}$$

are the Lagrange multipliers for the voltage violation duration limit (14).

(2). Decomposition: Thereafter, the processor decomposes augmented RS-HC into multiple individual period-level subproblems. A subproblem for sub-period j at iteration n, Sub-RS-HC is defined as follows, which is formulated by fixing the variables in other subproblems to the values obtained from the previous iteration.

$$min {\sum }_{c ∈ 𝒞} {\sum }_{φ ∈ {ψ}_{i}} ( \begin{matrix}\frac{1}{\vert 𝒞 \vert} {\sum }_{i ∈ 𝒢} {\sum }_{t ∈ {𝒯}_{j}} ( \text{?} - {P ℊ}_{i , t}^{φ , c . n} ) \\ + {\sum }_{i ∈ 𝒩} {\sum }_{t ∈ {𝒯}_{j} ⋂ {𝒯}_{d}} {{\sum }^{t}}_{k = t - d} ( {\overline{y}}_{i , k}^{φ , c , n} {\overline{λ}}_{i , t}^{φ , c , n} + {\underline{y}}_{i , k}^{φ , c , n} {\underline{λ}}_{i , t}^{φ , c , n} )\end{matrix} ) \qquad ( 24 )$$

$$\begin{matrix}+ {\sum }_{( i , k ) ∈ {ε}^{s}} ( {λ}_{ik}^{n} + {ω}^{s} ) {\sum }_{t ∈ {𝒯}_{j}} {γ}_{ik , t}^{n} \\ + {\sum }_{( i , k ) ∈ {ε}^{r}} ( {ν}_{ik}^{n} + {ω}^{r} ) {\sum }_{t ∈ {𝒯}_{j}} {ρ}_{ik , t}^{n}\end{matrix}$$

$$s . t . ( 8 ) - ( 13 ) ,$$

$$( 15 ) - ( 18 ) ,$$

$$a \to {a}^{c , n} ,$$

$$b \to {b}^{n} ,$$

$$∀ t ∈ {𝒯}_{j} ,$$

$$∀ c ∈ 𝒞$$

3). Coordination: Unlike traditional Lagrangian decomposition algorithms, the multipliers in (24), in some embodiments, are updated after solving each subproblem. To make sure that the multipliers are updated in acute angles, the following optimality condition needs to be satisfied.

$$L ( {a}^{c , n} , {b}^{n} , {λ}^{n} , {\overline{λ}}^{n} , {\underline{λ}}^{n} , {v}^{n} ) < L ( {a}^{c , n - 1} , {b}^{n - 1} , {λ}^{n} , {\overline{λ}}^{n} , {\underline{λ}}^{n} , {𝓋}^{n} ) \qquad ( 25 )$$

where L(a^{c,n}, bⁿ, λⁿ, λ̅ⁿ, λⁿ, vⁿ) is the objective value of RS-HC at iteration n. If (25) is not satisfied, then the processor sets a^{c,n}=a^{c,n-1}, bⁿ=bⁿ⁻¹, else the processor updates the multipliers as follows. Here the processor uses the following step-sizing formula:

$${\overline{λ}}_{i , l}^{φ , c , n + 1} = {[ {\overline{λ}}_{i , l}^{φ , c , n} + {ϛ}^{n} {\tilde{ℊ}}_{1 ic φ l}^{n} ]}^{+} , \qquad ( 26 )$$

$$∀ i ∈ 𝒩 ,$$

$$c ∈ C ,$$

$$φ ∈ {ψ}_{i} ,$$

$$l ∈ {𝒯}_{d}$$

$${\overline{λ}}_{i , t}^{φ , c , n + 1} = {[ {\underline{λ}}_{i , l}^{φ , c , n} + {ϛ}^{n} {\tilde{ℊ}}_{2 ic φ l}^{n} ]}^{+} ,$$

$$∀ i ∈ 𝒩 ,$$

$$c ∈ C ,$$

$$φ ∈ {ψ}_{i} ,$$

$$l ∈ {𝒯}_{d}$$

$${λ}_{i k}^{n + 1} = {[ {λ}_{i k}^{n} + {ϛ}^{n} {\tilde{ℊ}}_{i k}^{n} ]}^{+} ,$$

$$∀ ( i , k ) ∈ {ε}^{s}$$

$${ν}_{i k}^{n + 1} = {[ {λ}_{i k}^{n} + {ϛ}^{n} {\tilde{ℊ}}_{i k}^{n} ]}^{+} ,$$

$$∀ ( i , k ) ∈ {ε}^{r}$$

$${ϛ}^{n} = ξ \cdot \frac{{ϛ}^{n - 1} ‖ {\tilde{ℊ}}^{n - 1} ‖}{‖ {\tilde{ℊ}}^{n} ‖}$$

where ζⁿ is the stepsize at iteration n, [·]⁺ represents projection onto the positive orthant. \tilde{g}ⁿ is the surrogate subgradient vector at iteration n, which is given as:

$${\tilde{ℊ}}_{1 ic φ l}^{n} = {\sum }_{t = l - d}^{l} {\overline{y}}_{i , t}^{φ , c} - d , \qquad ( 27 )$$

$$∀ i ∈ 𝒩 ,$$

$$c ∈ 𝒞 ,$$

$$φ ∈ {ψ}_{i} ,$$

$$l ∈ {𝒯}_{d}$$

$${\tilde{ℊ}}_{2 ic φ l}^{n} = {\sum }_{t = l - d}^{l} {\underline{y}}_{i , t}^{φ , c} - d ,$$

$$∀ i ∈ 𝒩 ,$$

$$c ∈ 𝒞 ,$$

$$φ ∈ {ψ}_{i} ,$$

$$l ∈ {𝒯}_{d}$$

$${\tilde{ℊ}}_{ik}^{n} = {\sum }_{t ∈ 𝒯} {γ}_{i k , t} - {γ}_{ik}^{max} ,$$

$$∀ ( i , k ) ∈ {ε}^{s}$$

$${\tilde{ℊ}}_{ik}^{n} = {\sum }_{t ∈ 𝒯} {ρ}_{ik , t} - {ρ}_{ik}^{max} ,$$

$$∀ ( i , k ) ∈ {ε}^{r}$$

∥\tilde{g}ⁿ∥ is calculated as:

$$‖ {\tilde{ℊ}}^{n} ‖ = \sqrt{{\sum }_{i ∈ N} {\sum }_{c ∈ 𝒞} {\sum }_{φ ∈ {ψ}_{i}} {\sum }_{l ∈ {𝒯}_{d}} ( {( {\tilde{ℊ}}_{1 ic φ l}^{n} )}^{2} + {( {\tilde{ℊ}}_{2 ic φ l}^{n} )}^{2} ) + {\sum }_{( i , k ) ∈ {ε}^{s} ⋃ {ε}^{r}} {( {\tilde{ℊ}}_{ik}^{n} )}^{2}} \qquad ( 28 )$$

Rather than solely maximizing DER output, the optimization process minimizes expected DER curtailment, ensuring feasible integration within operational constraints. The final optimization output consists of precise control schedules for renewable generation dispatch, voltage regulator tap settings, and switch statuses, which are translated into executable grid control commands.

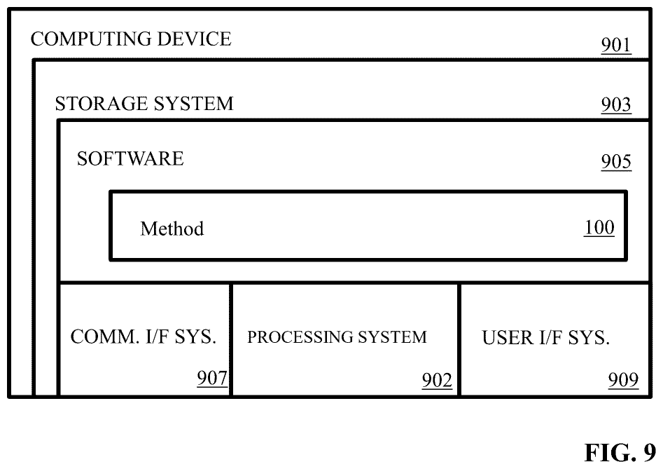

FIG. 9 shows a schematic of computing device 901 that is representative of any system or collection of systems in which the various processes, programs, services, and scenarios of some embodiments disclosed herein are implemented. Examples of computing device 901 include, but are not limited to, desktop and laptop computers, tablet computers, mobile computers, server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909. Processing system 902 is operatively coupled with storage system 903, communication interface system 907, and user interface system 909.

Processing system 902 loads and executes software 905 from storage system 903. Software 905 includes and implements principles of method, for example method 100, described in various exemplar embodiments. When executed by processing system 902, software 905 directs processing system 902 to operate as described herein for at least the various processes, operational scenarios, and sequences discussed in the foregoing implementations. Computing device/controller 901 may optionally include additional devices, features, or functionality not discussed for purposes of brevity, control various parameters of a power grid as per the method 100 described above.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, digital signal processors, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media/memory implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (the method 100, or any other method described in the present disclosure) may be implemented in program instructions and among other functions may, when executed by processing system 902, direct processing system 902 to operate as described with respect to the various operational scenarios, sequences, frameworks, and processes illustrated and/or discussed herein. For example, software 905 may include program instructions for implementing Newton Raphson method, PCH method with trust region, and line search method discussed herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to perform computer vision processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems, may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

### Experimental Study

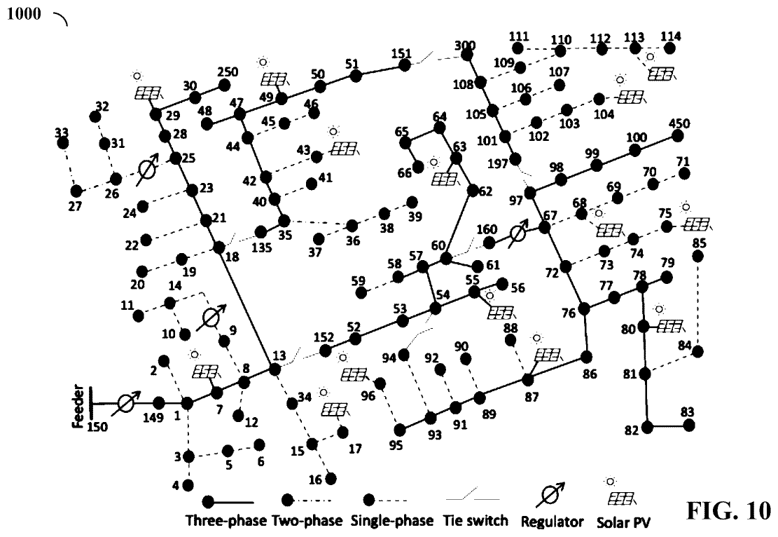

FIG. 10 is a schematic of an example power grid 1000 is shown. The power distribution system i.e., power grid 1000 includes different types of branches such as line segments, transformer or voltage regulator branches. For example, the system 1000 includes 4 voltage regulators, 6 tie switches, and 14 PV stations. For the study one year load and PV generation profiles from a open source resource are used. The system parameters are detailed in Table 1. For the MILP solver, use ILOG CPLEX 22.1.1.0 is used and the time limit is set to 1 hour.

TABLE 1
Systems parameters

| | | | |
|---|---|---|---|
| Parameter | value | Parameter | value |

| | | | | |
|---|---|---|---|---|
| Sgᵢ^{φ} | 50 | KVA | Sᵢₖ^{φ} | 2,000 KVA |
| Ūᵢ | 1.0583 | p.u. | M_{i, k} | 5 |
| Uᵢ | 0.90 | p.u. | γ_{i, k}^{max} | 4 |

| | | | |
|---|---|---|---|
| ϵ | 0.06 | ρ_{i, k}^{max} | 8 |

### Performance of GMM on DER and Load Prediction

For DER generation, the GMM is prepared using the past 30 days of historical data and assess their performance over a 7-day testing period. The performance of the GMM is checked with varying numbers of components K. The mean squared errors (MSE) of all PVs across all scenarios and testing days are presented in Table 2. Here the number of scenarios are set to 10. As shown, setting K=3 results in the lowest MSE, indicating that grouping the PVs into three clusters yields the best performance.

TABLE 2
Prediction MSE of PV under different K

| K | 1 | 3 | 5 | 10 | 14 |
|---|---|---|---|---|---|
| MSE | 0.00532 | 0.00504 | 0.00529 | 0.00532 | 0.00520 |

Similarly, the MSE of all loads across all scenarios and testing days are given in Table 3. The results show that grouping the load buses into five clusters provides the best performance.

TABLE 3
Prediction MSE of load under different K

| K | 1 | 3 | 5 | 10 | 20 |
|---|---|---|---|---|---|
| MSE | 0.00202 | 0.00214 | 0.00198 | 0.00199 | 0.00199 |

The complexity of the S-HC problem increases linearly with the number of scenarios. To save computation time, a small set of “representative scenarios” is selected. Table 4 gives the prediction MSE of PV and load under a different number of scenarios C. Accordingly, C=3 is selected to reduce computation time without sacrificing representativeness.

TABLE 4
Prediction MSE of PV/load under different C

| | Number of scenarios | | | | |
|---|---|---|---|---|---|
| | 1 | 3 | 5 | 10 | 20 |
| MSE (PV) | 0.00529 | 0.00511 | 0.00517 | 0.00504 | 0.00506 |
| MSE (load) | 0.00188 | 0.00186 | 0.00192 | 0.00198 | 0.00204 |

Then, the daily PV generation and load demand on bus 7, along with the GMM-predicted scenarios, is shown in FIG. 9. The figure demonstrates that the scenarios generated by the GMM effectively capture the actual PV generation and load demand.

### Performance Comparison on Hosting Capacity

In this subsection, the performance of MILP and SLR in solving the S-HC and RS-HC models, are compared respectively. Here, the temporal constraints only consider the daily maximum number of switch and regulator operations.

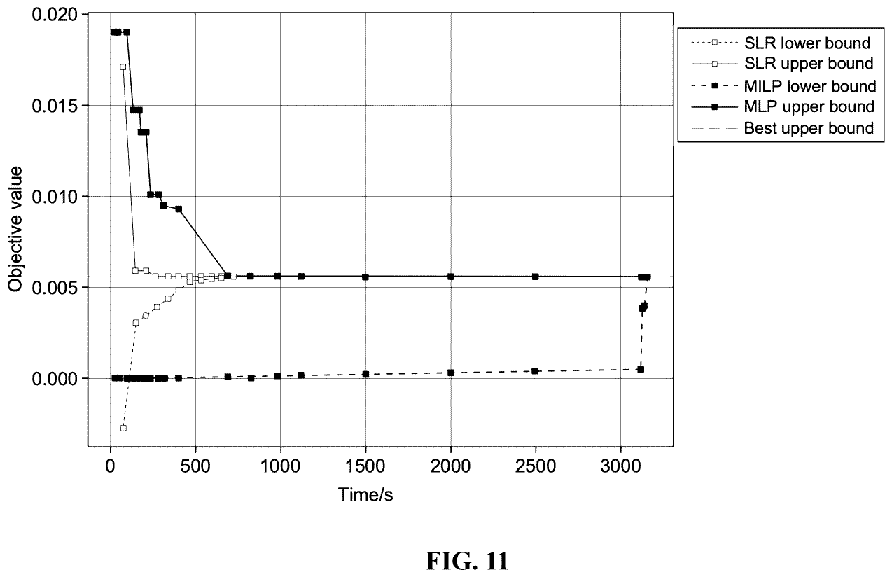

FIG. 11 illustrates the upper and lower bounds of each method throughout the solving process. For MILP, the upper and lower bounds are reported by CPLEX. In the case of SLR, the lower bound is derived from solving Sub-RS-HC at each iteration, while the upper bound is estimated using a heuristic algorithm. Here the sub-horizon is set to 4. The figure shows that SLR quickly finds a feasible solution after just a few iterations. Additionally, both methods ultimately arrive at the same solution.

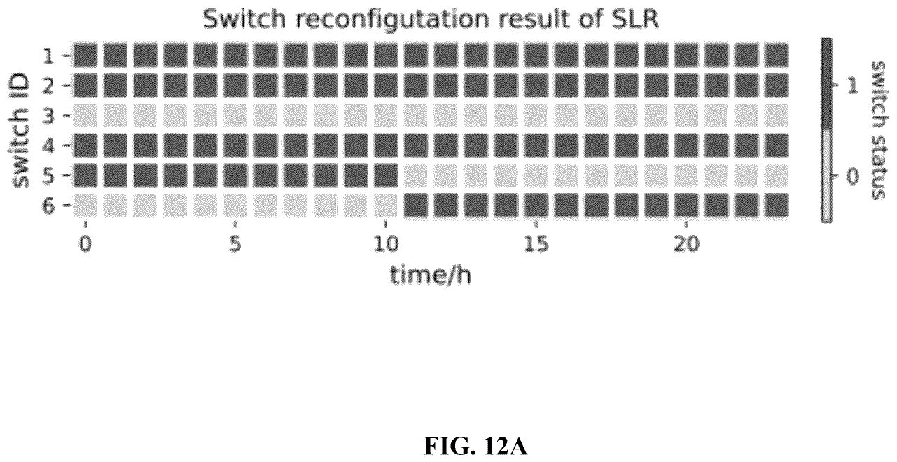

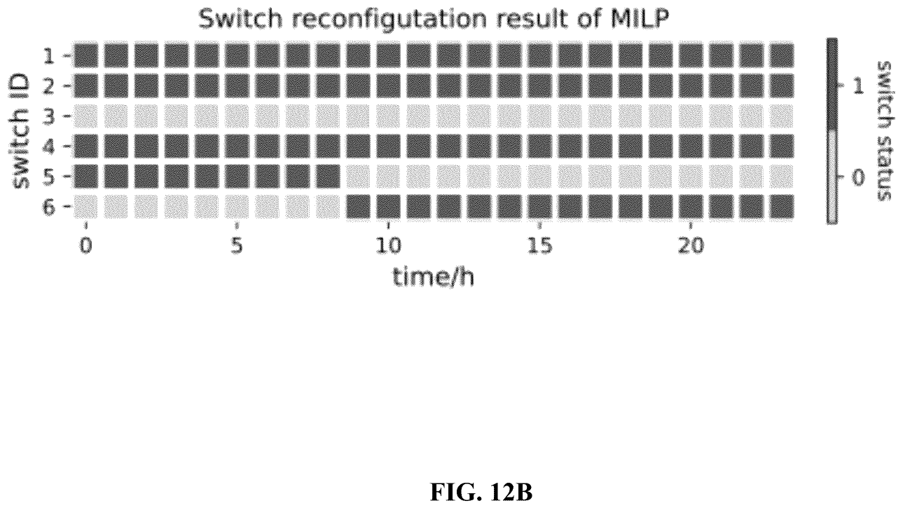

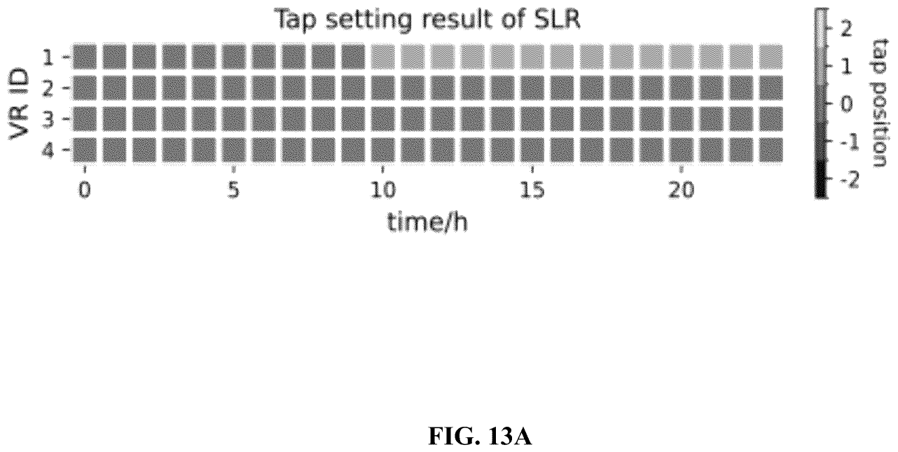

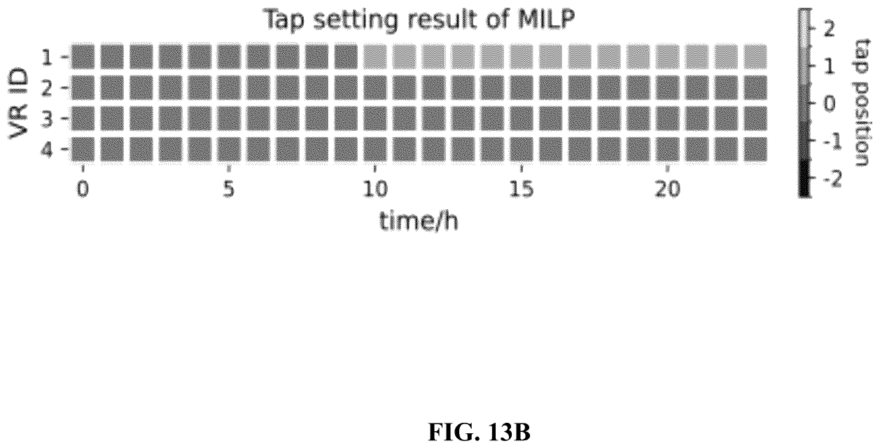

Next, the switch reconfiguration results and tap setting results for both methods are presented in FIG. 12A, FIG. 12B and FIG. 13A, FIG. 13B, respectively. To ensure the radial structure of the initial system topology, the statuses of the six switches are initially set to [1, 1, 0, 1, 1, 0]. The results of the switch reconfiguration process indicate that both SLR and MILP require two operations involving switches 5 and 6. The initial tap positions of all voltage regulators are set to 0. Similarly, both SLR and MILP require a single operation to adjust the tap of the first voltage regulator. These results highlight that SLR is capable of finding the same optimal solution as MILP but in significantly less time.

1. A method for controlling power distribution in a power grid with Distributed Energy Resources (DERs) integrated into the power grid, wherein a topology of the power grid is formed by various switch controllers and voltage regulators, the method comprising:
generating multiple representative scenarios forecasting DERs generation and load demand in the power grid over a prediction horizon;
determining control schedules for reconfigurable parameters of the power grid by employing an optimization technique by minimizing expected curtailment of the DERs while satisfying all generated scenarios as constraints;
translating the optimized control schedules into executable commands for one or a combination of the DERs, voltage regulators, and switch controllers; and
controlling one or a combination of the DERs, voltage regulators, and switch controllers of the power grid according to the executable commands.

2. The method of claim 1, wherein generating multiple representative scenarios comprises:
collecting a Gaussian Mixture Model (GMM) trained on historical DER generation and load demand data, wherein each Gaussian distribution forming the GMM corresponds to a portion of the power grid that includes a cluster of DERs serving the load demand;
determining a forecast of power grid operation over the prediction horizon;
dynamically updating weights of the Gaussian distributions in the GMM based on the forecast; and
sampling the GMM with the updated weights to generate multiple representative scenarios that capture stochastic variations in DER generation and load demand.

3. The method of claim 2, wherein the Gaussian Mixture Model (GMM) includes separate distributions for DER generation and load demand, each modeled independently, and wherein scenarios are generated by sampling the DER generation distribution and the load demand distribution independently to produce multiple representative scenarios for forecasting power grid operation.

4. The method of claim 2, wherein training the Gaussian Mixture Model (GMM) comprises:
clustering the DERs based on spatial proximity, grouping DERs that serve common load demands;
modeling a Gaussian distribution for each cluster, representing the stochastic characteristics of DER generation and load demand within the cluster; and
training the GMM using historical DER generation and load demand data to determine the mean and variance of each Gaussian distribution, thereby capturing the stochastic variations in DER output and load demand while reducing computational complexity.

5. The method of claim 1, wherein solving the optimization problem to determine control schedules comprises
formulating the minimization of expected DER curtailment as a Mixed-Integer Linear Programming (MILP) problem,
incorporating grid reconfiguration constraints, voltage regulation limits, and operational constraints of switch controllers and voltage regulators, and
solving the MILP problem to obtain optimal schedules for the reconfigurable parameters of the power grid.

6. The method of claim 5, wherein solving the MILP includes implementing a Surrogate Lagrangian Relaxation (SLR) algorithm with temporal decomposition to accelerate computation and enable real-time operational decisions.

7. The method of claim 6, wherein implementing the SLR algorithm comprises:
converting the MILP problem into a relaxed stochastic operational hosting capacity optimization model (RS-HC) by dualizing temporal constraints and augmenting the objective function with penalized constraint violations and Lagrange multipliers;
decomposing the RS-HC model into multiple independent subproblems, each corresponding to a distinct time period, enabling parallel or sequential optimization while ensuring temporal consistency through iterative variable updates; and
iteratively updating the Lagrange multipliers using a surrogate subgradient method, adjusting penalty terms based on constraint violations and guiding the optimization toward convergence by refining DER curtailment minimization over the prediction horizon.

8. The method of claim 7, wherein the penalized constraint violations include maximum number of allowed switch operations, maximum number of allowed tap position changes, maximum time steps for bus over voltage violations, and maximum time steps for bus under voltage violations.

9. The method of claim 1, wherein the reconfigurable parameters further include tie switch and sectionalizing switch statuses, enabling dynamic feeder reconfiguration to optimize power flow, enhance operational hosting capacity, and maintain grid stability by preventing overloads and voltage violations and imbalances.

10. The method of claim 1, wherein the executable commands for voltage regulators include optimized incremental tap adjustments.

11. The method of claim 1, wherein the optimization of switch controller schedules ensures radiality constraints in the distribution network.

12. A system for controlling a power grid, comprising:
a processor configured to execute instructions to:
generate multiple representative scenarios forecasting DERs generation and load demand in the power grid over a prediction horizon, and
determine control schedules for reconfigurable parameters of the power grid by employing an optimization technique by minimizing expected curtailment of the DERs while satisfying all generated scenarios as constraints;
a memory storing instructions and parameters for generating multiple scenarios and determining control schedules for reconfigurable parameters; and
a controller configured to control the power grid based on the determined control schedules and using the instructions and parameters stored in the memory.

13. The system of claim 12, wherein to generate multiple representative scenarios, the processor is configured to execute instructions to
collect a Gaussian Mixture Model (GMM) trained on historical DER generation and load demand data, wherein each Gaussian distribution forming the GMM corresponds to a portion of the power grid that includes a cluster of DERs serving the load demand;
determine a forecast of power grid operation over the prediction horizon; dynamically update weights of the Gaussian distributions in the GMM based on the forecast; and
sample the GMM with the updated weights to generate multiple representative scenarios that capture the stochastic variations in DER generation and load demand.

14. The system of claim 13, wherein to train the Gaussian Mixture Model (GMM), the processor is configured to execute instructions to:
cluster the DERs based on spatial proximity, grouping DERs that serve common load demands;
model a Gaussian distribution for each cluster, representing the stochastic characteristics of DER generation and load demand within the cluster; and
train the GMM using historical DER generation and load demand data to determine the mean and variance of each Gaussian distribution, thereby capturing the stochastic variations in DER output and load demand while reducing computational complexity.

15. The system of claim 12, wherein to determine control schedules, the processor is configured to execute instructions to:
formulate the minimization of expected DER curtailment as a Mixed-Integer Linear Programming (MILP) problem,
incorporate grid reconfiguration constraints, voltage regulation limits, and operational constraints of switch controllers and voltage regulators, and
solve the MILP problem to obtain optimal schedules for the reconfigurable parameters of the power grid.

16. The system of claim 15, wherein the processor is configured to execute instructions to implement a Surrogate Lagrangian Relaxation (SLR) algorithm with temporal decomposition to solve the MILP problem.

17. The system of claim 16, wherein to implement the SLR algorithm, the processor is configured to execute instructions to
convert the MILP problem into a relaxed stochastic operational hosting capacity optimization model (RS-HC) by dualizing temporal constraints and augmenting the objective function with penalized constraint violations and Lagrange multipliers;
decompose the RS-HC model into multiple independent subproblems, each corresponding to a distinct time period, enabling parallel or sequential optimization while ensuring temporal consistency through iterative variable updates; and
iteratively update the Lagrange multipliers using a surrogate subgradient method, adjusting penalty terms based on constraint violations and guiding the optimization toward convergence by refining DER curtailment minimization over the prediction horizon.

18. The system of claim 17, wherein the penalized constraint violations include maximum number of allowed switch operations, maximum number of allowed tap position changes, maximum time steps for bus over voltage violations, and maximum time steps for bus under voltage violations.

19. The system of claim 12, wherein the reconfigurable parameters further include tie switch and sectionalizing switch statuses, enabling dynamic feeder reconfiguration to optimize power flow, enhance operational hosting capacity, and maintain grid stability by preventing overloads and voltage violations and imbalances.
